(19) United States
(12) Patent Application Publication
(10) Pub. No.: US 2024/0408987 A1
(43) Pub. Date: Dec. 12, 2024

(54) MOBILE INTELLIGENT CHARGING SYSTEM FOR ELECTRIC VEHICLES

(71) Applicants: CHUN-PENG KUO, Taipei City (TW); CHUN-YI SU, Taipei City (TW); SHENG-HSIANG HUANG, Taoyuan City (TW)

(72) Inventors: CHUN-PENG KUO, Taipei City (TW); CHUN-YI SU, Taipei City (TW); SHENG-HSIANG HUANG, Taoyuan City (TW)

(21) Appl. No.: 18/633,543

(22) Filed: Apr. 12, 2024

(30) Foreign Application Priority Data
Jun. 7, 2023 (TW) 112205791

(51) Int. Cl. B60L 53/34; B60L 53/30; B60L 53/65

(52) U.S. Cl. CPC B60L 53/34; B60L 53/305; B60L 53/65

(57) ABSTRACT

A mobile intelligent charging system includes a mobile charging station, a cloud platform for controlling the mobile charging station to be charged while self-moving by an AGV technology, and a payment module connected with the mobile charging station and the cloud platform. The cloud platform includes a control module and a monitoring module. The positioning information is transmitted through the monitoring module, and the person who wants to charge obtains the identification code through a mobile communication device, and uses the positioning information to activate the mobile charging station so that it can be charged according to the positioning information. The charging vehicle is self-propelled to the parking location of the electric vehicle of the person who wants to charge it. The above method can carries out the charging and payment, thus achieving high mobility and easy access to the on-site charging.

### CROSS-REFERENCES

The present application is based on, and claims priority from, Taiwan utility model patent application No. 112205791, filed Jun. 7, 2023, the disclosure of which is hereby incorporated by reference herein in its entirety.

### FIELD OF THE INVENTION

The present disclosure relates to a charging system, and more particularly, to a mobile intelligent charging system for electric vehicles, which has high mobility and can be used for local charging in coordination with the parking location of vehicles and provides easy access to charging.

### DESCRIPTION OF RELATED ART

The green energy industry is a future trend. Nowadays, vehicles (locomotives or cars) that originally used oil as energy supply have been gradually replaced by electric energy to develop power supply charging equipment for electric vehicles. Therefore, power supply equipment is obviously one of the indispensable energy sources in the future.

As far as charging settings of electric vehicles are concerned, at present, each charging pile corresponds to one parking space, and charging piles are fixed at specific locations is adopted, that is to say, electric vehicles can only be charged by charging piles arranged on parking spaces in specific locations. However, the charging piles in specific locations can only be set up after applying for power feeding from Taipower (which is a Taiwanese power company) in advance, so that the charging piles are able to charge vehicles. The point is that due to the environmental, economic and legal concerns, existing public parking lots or private parking lots, including parking lots of community houses and commercial buildings face the difficulty of arranging a charging pile for each parking space, thus causing the problems of charging for electric vehicles.

### SUMMARY OF THE INVENTION

The purpose of the present disclosure is to provide a mobile intelligent charging system for electric vehicles, which can cooperate with the parking locations of existing vehicles to charge on the spot, thus providing a highly mobility and easy access to charging.

Another purpose of the mobile intelligent charging system for electric vehicles is of the present disclosure is that the mobile intelligent charging system can be self-charged with existing fixed charging piles, so as to store electric energy to continuously meets the need for mobile charging.

In order to achieve the above objectives, the present disclosure provides a mobile intelligent charging system that comprises a mobile charging station, a cloud platform for controlling the mobile charging station to be charged while self-moving by an AGV technology, and a payment module connected with the mobile charging station and the cloud platform. The cloud platform comprises a control module and a monitoring module. The control module comprises a memory and a server, and the memory is used to store information of a map and route of each parking lot and information of each parking space. The server is connected with the memory and the payment module, and at least assigns each parking space with an identification code; after the identification code is read, the server sends a positioning message of a parking location where the identification code is located to the monitoring module, and transmits a payment message of the payment module according to initiation of the mobile charging station. The monitoring module is wirelessly connected with the control module and comprises a positioning navigator and a monitor, wherein the positioning navigator is arranged on the mobile, and after receiving the positioning message of the field map and route information, the positioning navigator transmits a positioning message to the mobile charging station; the monitor is connected with the positioning navigator to at least display the route of the positioning message.

### BRIEF DESCRIPTION OF DRAWINGS

In order to allow the abovementioned and other purposes, features, advantages and embodiments of the present disclosure to be more clearly understood, the accompanying drawings are described as following:

FIG. 1 is a block-flowchart illustrating a mobile intelligent charging system for an electric vehicle according to a first embodiment of the present disclosure.

FIG. 2 is a flowchart illustrating the scenario where the control module and monitoring module of the mobile intelligent charging system for electric vehicles are charged according to an embodiment of the present disclosure.

FIGS. 3A and 3B are exploded diagram and assembly diagram of the mobile charging station of the mobile intelligent charging system according to an embodiment of the present disclosure, respectively.

FIG. 4 is a flowchart illustrating that the electric vehicle is charged using the inventive mobile intelligent charging system.

FIG. 5 is a diagram illustrating a mobile intelligent charging system for electric vehicles applied to a parking lot according to a first embodiment of the present disclosure.

FIG. 6 is a block-flowchart illustrating a mobile intelligent charging system for electric vehicles according to a second embodiment of the present disclosure.

FIG. 7 is a diagram illustrating a mobile intelligent charging system for electric vehicles applied to a parking lot according to a second embodiment of the present disclosure.

### DETAILED DESCRIPTION OF THE INVENTION

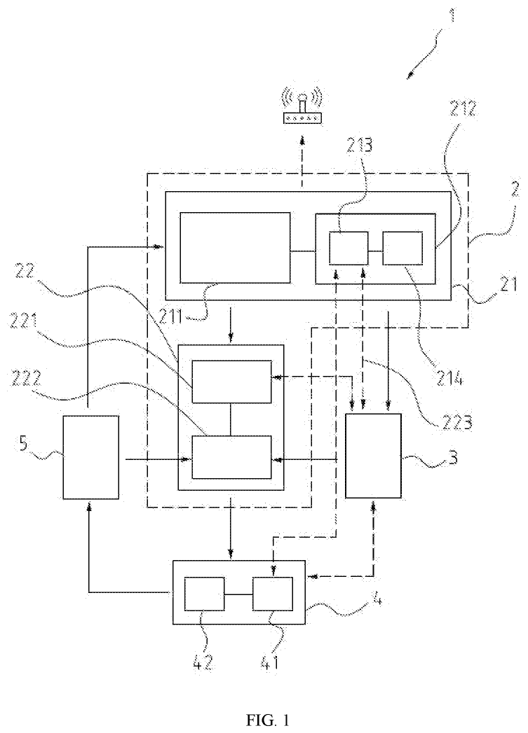

Please refer to FIG. 1 to FIG. 5, which illustrate a first embodiment of a mobile intelligent charging system for electric vehicles according to the present disclosure. As shown in FIG. 1, the mobile intelligent charging system 1 comprises a cloud platform 2, a mobile charging station 3 and a payment module 4, wherein the cloud platform 2 controls the mobile charging station 3 to self-move and be positioned by the Automated Guided Vehicle (AGV) technology, thereby being charged. The cloud platform 2 comprises a control module 21 and a monitoring module 22, wherein the control module 21 comprises a memory 211 and a server 212, and the memory 211 is used for storing the map and route information of each parking lot and the information of each parking lot. The server 212 is connected with the memory 211 and the payment module 4 and assigns each parking space with an identification code 213. The identification code 213 can be carried out by a QR code, which is readable by mobile communication devices, such as smart phones, portable computers, tablets, etc. In addition, the server 212 comprises a QR code reader 214, which can read the identification code 213 and then send a positioning message of the field map and route information of the parking location of the mobile communication device that transmits the identification code 213 to the monitoring module 22.

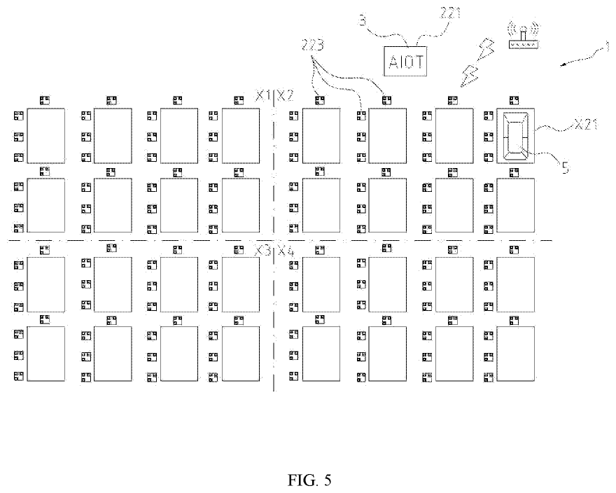

The monitoring module 22 is wirelessly connected with the control module 21 and comprises a positioning navigator 221 and a monitor 222, wherein the positioning navigator 221 has a camera (not shown in the figure), such as GPS, A-GPS, Bluetooth, infrared ray and magnetic track, which can be installed on the mobile charging station 3 to receive the positioning message of the field map and route information and then transmit the positioning message to the mobile charging station 3. The monitor 222 is wirelessly connected with the positioning navigator 221, and can be arranged in connection with the host computer of the administrator where the cloud platform 2 is located, and is used for displaying the route of the positioning message, which refers to the location where the mobile charging station 3 is located, to the parking location where the identification code 213 is located. The route depends on conditions such as the field space, ground flatness, etc. A route identification code 223 (referring to FIG. 5) is set every 1-3 meters. The route identification code 223 adopts QR code, and the camera of the positioning navigator 221 receives the QR codes of the route identification codes 223, which is beneficial for the mobile charging station 3 to smoothly follow the route of the positioning message.

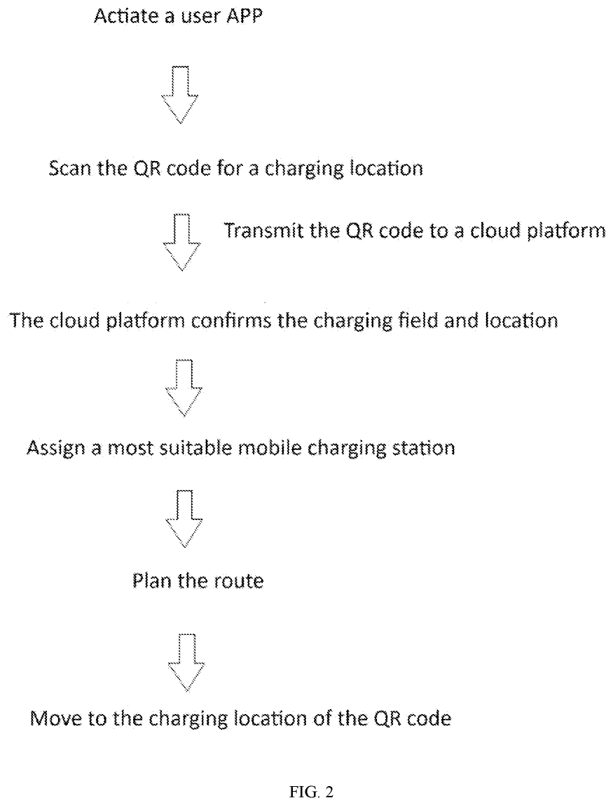

Please refer to FIG. 2. The collaboration flow of creating the monitoring module 22 is shown in FIG. 2. After the APP is activated through the mobile communication device, the user can scan the QR code corresponding to the charging location in the parking space. After the cloud platform 2 receives the QR code, the server 212 and the memory 211 confirm the charging field and location. After confirmation, a positioning message will be transmitted to the mobile charging station 3 which is most suitable to move to the parking location for charging. The mobile charging station 3 reads the QR code of the route identification code 223 through the positioning navigator 221 (e.g., a camera) to plan the route and then move to location specified by the QR code 213 of the charging location.

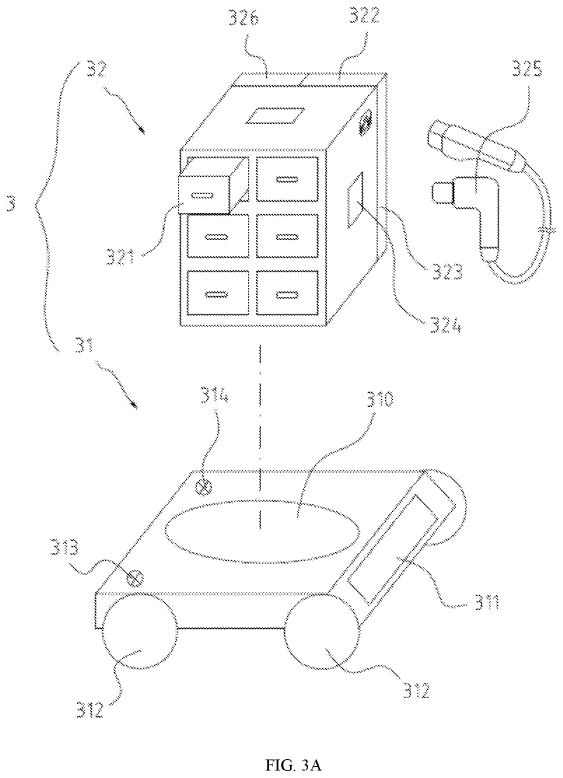

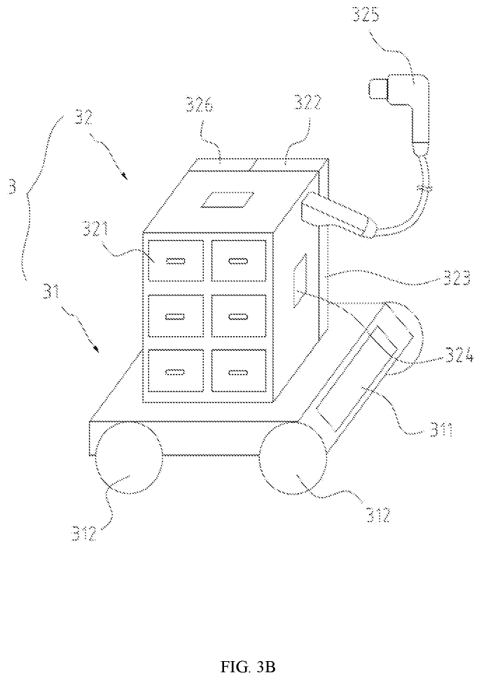

Please refer to FIGS. 3A and 3B which illustrate the scenario of AI Internet of Things (AIoT). The mobile charging station 3 is connected with the control module 21 and comprises a body 31 and battery storage cabinet 32 assembled on the body 31, wherein the body 31 has a fixed bearing 310 and a servo drive motor 311. The mobile charging station 3 also comprises wheels 312 driven by the servo drive motor 311. A power connection port 313 of the mobile charging station 3 can be connected with an external power source (such as the feeder end of Taipower, a Taiwanese power company). A communication port 314 of the mobile charging station 3 is connected with a communication element (such as WiFi). The body 31 is assembled with the battery energy storage cabinet 32 via the fixed bearing 310. After the communication port 314 receives the positioning message, the servo drive motor 311 is started to self-move by the AGV technology. The battery energy storage cabinet 32 contains at least an electric energy storage battery 321, a bidirectional power conversion system (PCS) 322, a battery management system (BMS) 323, a temperature management system (TMS) 324 and an external charging gun 325 connected with the Taipower feeder through the power connection port 313. The electricity is stored in the electricity storage battery pack 321. Once there is a need for charging, charging is performed by the external charging gun 325. After charging is complete, a payment message is transmitted to the payment module 4 through the control module 21, and the electricity of the electricity storage battery pack 321 is absorbed or emitted by the bidirectional power conversion system 322, and the battery state of the electricity storage battery pack 321 is monitored by the battery management system 323, and the electricity storage battery pack 321 is maintained at the optimal working temperature by the temperature management system 324. It is worth mentioning that when charging is started, the mobile charging station 3 selects the most suitable mobile charging station 3 for charging according to the following order: the remaining power of the battery storage cabinet 32, if the battery storage cabinet 32 of the lowest power cost, and whether the moving distance of the mobile charging station 3 is closest to the route of the positioning message.

Furthermore, the battery storage cabinet 32 can be further provided with a recall charging module 326, which is wirelessly connected with the control module 21, the monitoring module 22, the battery management system 323 and the mobile charging station 3, and comprises a call-back interface (not shown in the figure), which can transmit a “replenishing battery message” to the control module 21 according to the battery condition monitored by the battery management system 323 when the battery storage is insufficient. After the monitoring module 22 receives a homing message from the control module 21, the monitoring module 22 transmits a homing route message to the mobile charging station 3, so that the mobile charging station 3 can move to the place with charging equipment via the AGV technology for charging.

Please refer to FIG. 1 again. The payment module 4 is connected to the payment system of a financial bank, and is started by the mobile charging station 3. The payment module 4 comprises a transaction unit 41 and a payment unit 42. The transaction unit 41 comprises a payment type interface, which is linked by the identification code 213 of the control module 21.

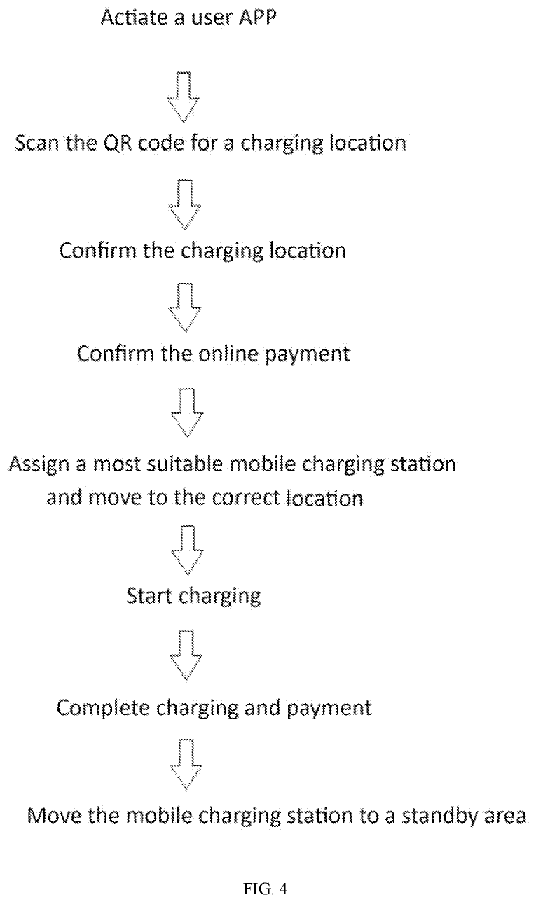

When the identification code 213 is activated, the payment type interface of the transaction unit 41 shows a payment option message that contains a plurality of options of payment methods, for the charger (i.e., the customer who enables the identification code) to choose a payment method. The payment unit 42 is connected with the transaction unit 41 and has a payment interface. When receiving the payment message, the payment unit 42 deducts money from the user according to the payment option message of the transaction unit 41. Please further refer to FIG. 4, which is a flowchart illustrating the cooperation among the payment module 4, the control module 21 and the monitoring module 22. As shown in the figure, after the user starts the APP through the mobile communication device and scans the QR code of the charging of the charging location at the parking space. After the cloud platform 2 receives the QR code, the server 212 and the memory 211 confirm the charging field and location. After the charging location is confirmed, the online payment will be confirmed (through the cooperative operation of the payment module 4). After the online payment is confirmed, the process of the monitoring module 22 described in FIG. 2 will be carried out. After the cloud platform 2 receives the QR code, the server 212 and the memory 211 confirm the charging field and position. After confirmation is done, a positioning message will be transmitted to the mobile charging station 3 which is most suitable one to move to the parking location for charging. The mobile charging station 3 reads the QR code 213 through the positioning navigator 221 (e.g., a camera) for route planning and then moves to the QR code of the charging location, so that the external charging gun 325 can start charging. The payment can be done by the payment unit 42 after the charging is complete, and then the mobile charging station 3 returns to the standby area.

Please refer to FIG. 5 for an example of the application of the mobile intelligent charging system 1 in a parking lot. As shown in the figure, the parking lot has parking lots X1 and X2. When the vehicle 5 is driven into the parking place X21 of the parking lot X2, the user starts the APP through the mobile communication device and scans the QR code of the charging location at the parking place. As described in FIG. 1 and FIG. 4, after the cloud platform 2 receives the QR code, the server 212 and the memory 211 confirm the charging field and location and online payment. After confirmation is done, a positioning message will be transmitted to the most suitable mobile charging station 3 (represented by AIoT in the figure). The mobile charging station 3 reads the QR code 213 through the camera of the positioning navigator 221 installed thereon for route planning, and then moves to the charging location where is the QR code is located for performing charging and associated payment operations.

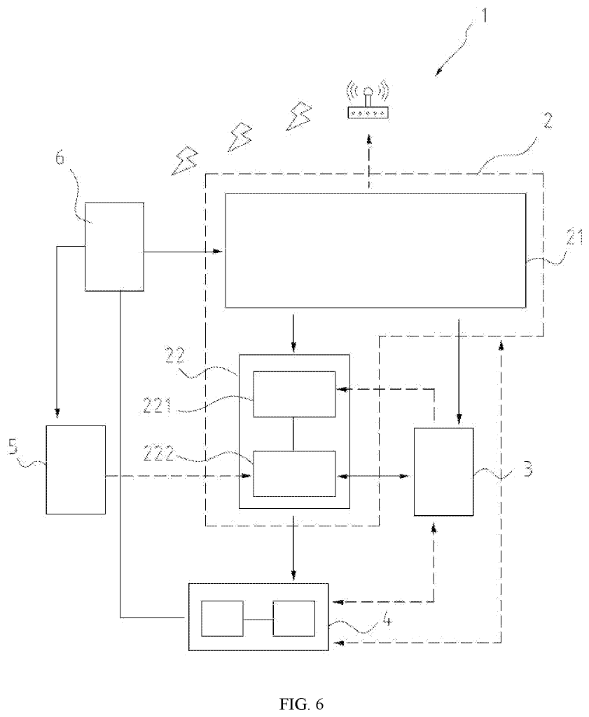

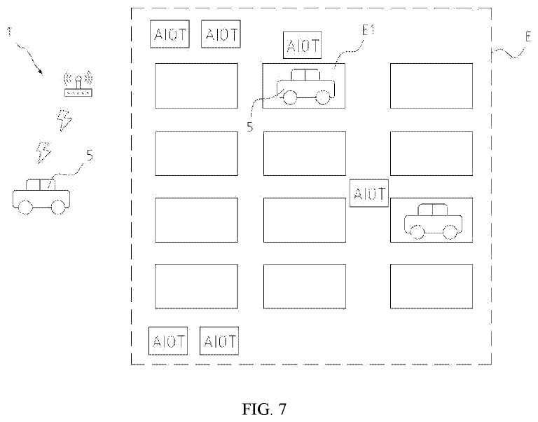

Please refer to FIGS. 6 to 7. FIG. 6 is a block-flowchart illustrating a mobile intelligent charging system for electric vehicles according to a second embodiment of the present disclosure. FIG. 7 is a diagram illustrating a mobile intelligent charging system for electric vehicles applied to a parking lot according to a second embodiment of the present disclosure. As shown in FIG. 6, the difference between the second embodiment and the first embodiment is that in the second embodiment, the mobile intelligent charging system 1 is wirelessly connected with the parking lot management system 6 while the route identification code 223 applied in the first embodiment is omitted, in which the mobile intelligent charging system 1 also comprises a cloud platform 2 that comprises a control module 21 and a monitoring module 22, a mobile charging station 3, and a payment module 4. When the vehicle 5 is to be parked, upon the parking lot management system 6 shows the parking is available, the identification code and positioning message provided by the control module 21 provides the information of the idle parking places that are available for parking. As shown in FIG. 7, when the vehicle 5 drives into the idle parking location E1 of the parking lot E, charging can be carried out through the flows introduced in FIGS. 1 and 4 according to the first embodiment of the present disclosure.

What is claimed is:

1. A mobile intelligent charging system for an electric vehicle, externally connected with a financial bank payment system, and comprising a mobile charging station, a cloud platform for controlling the mobile charging station to be charged while self-moving by an AGV technology, and a payment module connected with the mobile charging station and the cloud platform, wherein the cloud platform comprises a control module and a monitoring module; the mobile intelligent charging system characterized in that:
the control module comprises a memory and a server, the memory is used to store information of a map and route of each parking lot and information of each parking space; the server is connected with the memory and the payment module, and at least assigns each parking space with an identification code; after the identification code is read, the server sends a positioning message of a parking location where the identification code is located to the monitoring module, and transmits a payment message of the payment module according to initiation of the mobile charging station;
the monitoring module is wirelessly connected with the control module and comprises a positioning navigator and a monitor, wherein the positioning navigator is arranged on the mobile, and after receiving the positioning message of the field map and route information, the positioning navigator transmits a positioning message to the mobile charging station; the monitor is connected with the positioning navigator to at least display the route of the positioning message;
the mobile charging station is connected with the control module and the monitoring module, and comprises a body and a battery energy storage cabinet assembled on the body, wherein the body comprises a fixed bearing, a servo drive motor, and wheels driven by the servo drive motor; a power supply connection port arranged to connect with an external power source and a communication port arranged to connect with a communication element are integrated with the battery energy storage cabinet through a fixed bearing; and after receiving a positioning message transmitted by the positioning navigator through the communication port, the servo drive motor is enabled to cooperate with the AGV technology to self-move along the route of the positioning message; the battery energy storage cabinet at least contains an electric energy storage battery, a bidirectional power conversion system, a battery management system (BMS), a temperature management system connected with the electric energy storage battery, and an external charging gun connected with the electric energy storage battery; the battery energy storage cabinet is connected with charging equipment via the power supply port to store the electric energy in the electric energy storage battery; the external charging gun is arranged to perform charging when there is a need, and when charging is complete, the control module transmits a payment message to the payment module, and the bidirectional power conversion system absorbs or emits electricity of the electricity storage battery, and the battery management system monitors battery state of the electricity storage battery, and the temperature management system ensures that the electricity storage battery is maintained at an optimal working temperature;
the payment module is externally connected to the financial bank payment system and enabled by the mobile charging station, and has a transaction unit and a payment unit; the transaction unit has a payment type interface which is linked to an identification code of the control module; when the identification code is activated, the payment type interface releases a plurality of payment option messages to provide a charger who started the identification code with options of payment methods; the payment unit is connected with the transaction unit and has a payment interface, and performs debit operations on the charger according to the payment option message of the transaction unit when a payment message is received.

2. The mobile intelligent charging system for the electric vehicle according to claim 1, wherein the identification code provided by the server adopts a Quick Response (QR) code, and the server correspondingly comprises a QR code reader for reading the identification code.

3. The mobile intelligent charging system for the electric vehicle according to claim 1, wherein the server transmits the positioning information by wireless transmission through the gateway, and the route of the positioning information refers to the location where the mobile charging station is located to the parking location where the identification code is located, and the route is provided with a route identification code every 1-3 meters according to conditions of field space and ground flatness.

4. The mobile intelligent charging system for the electric vehicle according to claim 3, wherein the positioning navigator adopts at least one of a GPS, A-GPS, Bluetooth, infrared, magnetic track and Quick Response (QR) code.

5. The mobile intelligent charging system for the electric vehicle according to claim 4, wherein the route identification code adopts Quick Response (QR) code, and the positioning navigator comprises a camera for receiving the QR code, so that the mobile charging station can smoothly follow the route of the positioning message to self-move to a target location.

6. The mobile intelligent charging system for the electric vehicle according to claim 1, wherein the mobile charging station selects a most suitable mobile charging station for charging according to the order of the following elements: remaining power of the battery storage cabinet, whether the battery storage cabinet is of lowest power cost, and whether a moving distance of the mobile charging station is closest to the route of the positioning message.

7. The mobile intelligent charging system for the electric vehicle according to claim 6, wherein the battery energy storage cabinet is further provided with a recall charging module wirelessly connected with the control module, the monitoring module and the battery management system, and wirelessly connected with the mobile charging station; the battery energy storage cabinet comprises a recall interface which can transmit a replenishing battery message to the control module according to the battery condition monitored by the battery management system when the battery storage is insufficient; the control module transmits a homing message for the monitoring module to receive, and then the monitoring module transmits a homing route message to the mobile charging station, so that the mobile charging station self-moves to the charging equipment via an AGV technology for charging.

8. The mobile intelligent charging system for the electric vehicle as claimed in any one of claim 7, further wirelessly connected with the parking lot management system, wherein the identification code and the positioning message of the control module correspond to an idle parking location which is available for parking.

9. A mobile intelligent charging system for electric vehicles, externally connected to the financial bank payment system, and comprising a mobile charging station, a cloud platform that controls the mobile charging station to be charged while self-moving by an AGV technology, and a payment module connected with the mobile charging station and the cloud platform, wherein the mobile charging station comprises a body and a battery storage cabinet with an external charging gun assembled on the body, the body comprises a fixed bearing, a servo drive motor, and wheels driven by the servo drive motor; a power supply connection port arranged to connect with an external power source and a communication port arranged to connect with a communication element are integrated with the battery energy storage cabinet through a fixed bearing; the mobile charging station self-moves to a parking a parking location for electric vehicles to be charged when the communication port receives a route transmitted from the cloud platform and is charged by the external charging gun on the battery energy storage cabinet, and then the payment module deducts money after charging is complete.

10. The mobile intelligent charging system for the electric vehicle according to claim 9, wherein the battery storage cabinet contains interconnected electric energy storage batteries, a bidirectional power conversion system, a battery management system (BMS) and a temperature management system (TMS) connected with the electric energy storage batteries, wherein the electric energy storage batteries are composed of a plurality of pluggable electric energy storage cabinets, electric energy of the electric energy storage batteries is absorbed or emitted by the bidirectional power conversion system, battery state of the electric energy storage batteries is monitored by the battery management system, and the electric energy storage batteries are maintained at an optimal operation temperature by the temperature management system.
